(19) United States
(12) Patent Application Publication
(10) Pub. No.: US 2010/0115523 A1
(43) Pub. Date: May 6, 2010

(54) METHOD AND APPARATUS FOR ALLOCATING TASKS AND RESOURCES FOR A PROJECT LIFECYCLE

(75) Inventor: Boris Kuschel, Delson (CA)

Correspondence Address: Dan Salehi;The Salehi Law Group, 8 Crystalglen Street, Aliso Viejo, CA, 92656, US

(73) Assignee: INTERNATIONAL BUSINESS MACHINES CORPORATION, Armonk, NY (US)

(21) Appl. No.: 12/262,062

(22) Filed: Oct. 30, 2008

(51) Int. Cl. G06F 9/50; G06F 9/46

(52) U.S. Cl. 718/103; 718/104

(57) ABSTRACT

The present invention relates to the allocation of resources to address scope items against an iteration of a project based on a rule set described by a decision matrix and threshold values. Rather than changing work item start and end dates based on resource availability, the present invention adds, modifies, and removes content from a collection of scope item items and allocates them to resources based on the skills required, the priority, estimated work and target iteration of the scope item items.

### BACKGROUND

1. Field of the Invention

The present invention related generally to scheduling and resource allocation for a project, and more specifically to a leveling engine to allocate work to resources given priorities and constraints.

2. Description of Related Art

Agile project development is a conceptual framework for undertaking software engineering projects. There are a number of Agile project development methods, such as those espoused by “The Agile Alliance”, a non-profit organization. Most Agile methods attempt to minimize risk by completing project tasks, such as developing software, in short time boxes, called iterations, which typically last one to four weeks. Each iteration is like a miniature project of its own, and includes all of the tasks necessary to release the mini-increment of new functionality: planning, requirements-analysis, design, coding, testing, and documentation.

In a resource leveling approach, resources are added to those that were used in a prior development project to reduce an implementation time that was required for implementing the prior development project. Traditional resource leveling of resources involves gauging project priorities against resource availability and activity interdependency in order to schedule resources efficiently against a work breakdown structure.

Traditional leveling methods can use task constraints, such as “must start on day”, “must finish on day”, and “must start and finish on day.” A traditional leveling engine will then assign resource time against tasks in the most efficient way possible in order to effectively use resources. Work item groups, which are also called “deliverables”, “summary tasks”, “work products”, and “iterations” are adjusted according to resource availability. It is therefore possible that end dates and start dates of these task groups are re-scheduled. In order to accomplish this, the planning and scheduling phase is conducted in which every work item is scheduled and resources assigned before any leveling can take place. After leveling has taken place, the dates are adjusted according to constraints placed on individual work items.

In this mode of leveling, the Work Breakdown Structure (WBS) is a static entity and the WBS is never modified in lieu of resource availability and capacity. Agile projects can be considered a collection of work item groups, called iterations that have fixed state and end dates and in which resources are committed for all or fraction of their available time. The work items that are performed in the iteration depends on the capacity, priority and skill set of the resources allocated to the iteration. The work items preformed during iteration defines the content of iteration. Planning in agile projects does not involve the construction of a WBS to the individual work item level but only to the work item group, or iteration level. In addition, the agile iterations are fixed in nature and a resource leveling is not permitted to change these dates. However, it is permitted to take work items in and out of iterations, thus changing the content based on resource availability.

The other artifacts used in planning are a collection, or bucket, of work items, requirements, change requests, and other scope item and scope item elements which need to be addressed in iterations. This collection is aligned with the agile iteration plan by allocating elements from the bucket to resources committed to the iterations. A planner performs an allocation based on account priority and the skills and competencies of the resources allocated to the iteration.

Thus, there is a need of for such algorithms that are related to the benefits of agile project planning versus that of the traditional leveling method.

### SUMMARY

In one embodiment, the invention relates to a method and apparatus of allocating tasks and resources for a project lifecycle, comprising: defining a plurality of scope items for a project iteration; associating each scope item with at least one tag, each tag being assigned one or more values related to a required skill or experience level; identifying a plurality of resources that are potentially available to work during the project iteration; associating each resource with at least one tag; determining a matching score for each scope item, the matching score based on matching criteria between a range of values corresponding to the resource tags and the scope item tags; determining a work priority for each scope item based on a matching score as determined by a decision matrix; calculating a plurality of completion paths using the decision matrix, the completion paths based on various combinations of work priorities and resource allocations; and displaying the total number of completions paths in a graph of all possible valid resource and scope item matches as determined by user assigned weights in the decision matrix, wherein the path of least score being the most effective combination of tag criteria and resource availability.

### BRIEF DESCRIPTION OF THE DRAWINGS

These and other embodiments of the invention will be discussed with reference to the following non-limiting and exemplary illustrations, in which like elements are numbered similarly, and where:

FIG. 1 illustrates the cooperation between the project management system of the present invention and an organization to which the system applies;

FIG. 2 is a flowchart illustrating the process of allocating tasks and resources for a project lifecycle according to an embodiment of the present invention;

FIG. 3A shows an exemplary embodiment of the decision matrix;

FIG. 3B shows an exemplary embodiment of an iteration match generated by the decision matrix;

FIG. 4A illustrates an iteration calendar prior to execution of any scope items;

FIG. 4B illustrates resources with various competencies relating to the iteration calendar in FIG. 4A.

FIG. 5A illustrates an iteration calendar after leveling during planning;

FIG. 5B illustrates resources with various competencies relating to the iteration calendar in FIG. 5A.

FIG. 6A illustrates an iteration calendar with leveling during execution; and

FIG. 6B illustrates resources with various competencies relating to the iteration calendar in FIG. 6A.

### DETAILED DESCRIPTION

In an exemplary embodiment, this invention relates to a leveling algorithm for agile projects. Rather than changing work item start and end dates based on resource availability, which is done in contemporary leveling algorithms, this new algorithm adds, modifies, and removes content from a collection of scope item, scope item and work artifacts, and allocates them to resources based on the skills required, the priority, estimated work and target iteration that are marked on the artifacts in the collection.

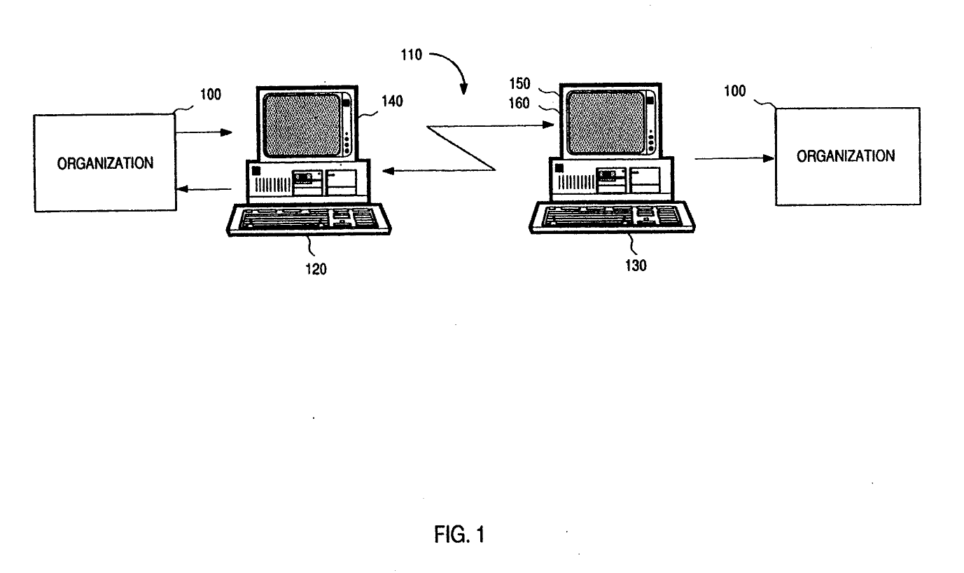

FIG. 1 illustrates the cooperation between an organization 100 and a project management system 110, which coordinates projects undertaken by organization 100. Organization 100 represents any governmental, business, non-profit, or other association which undertakes complex projects. Organization 100 includes numerous resources which are coordinated so that an undertaken project may be successfully completed. These resources include employees or other personnel, raw materials, equipment, consumable supplies, services, and the like. In general terms, the organization's resources must be assigned, applied, spent, or otherwise allocated to a project in order for the project to be completed. Preferably, the resources are available when needed, and are allocated only as needed to accomplish various tasks required to complete the project. Otherwise, the project may not be completed on time, or resources may be used inefficiently in completing the project.

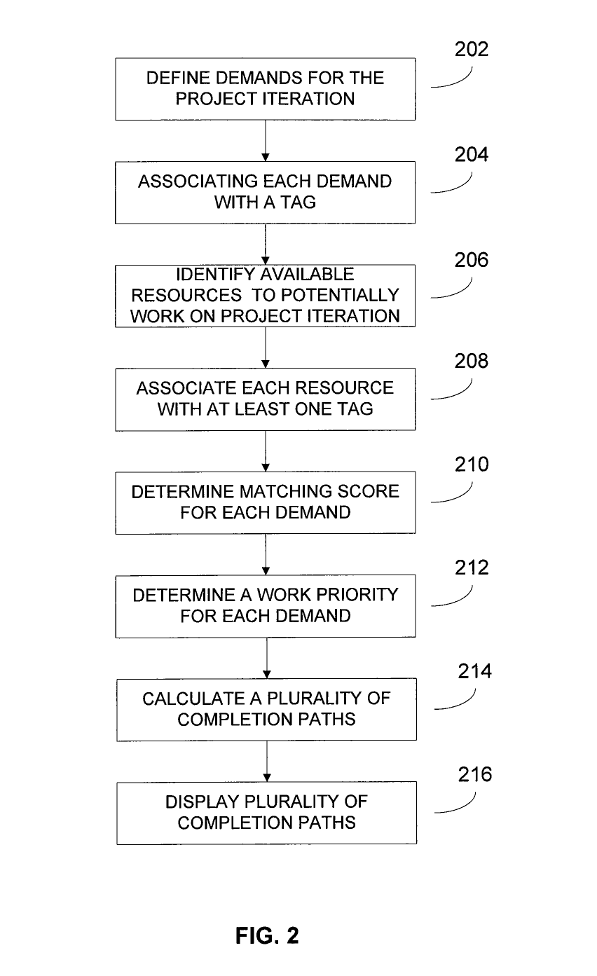

FIG. 2 is a flowchart illustrating the process of allocating tasks and resources for a project lifecycle according to an embodiment of the present invention. In step 202, scope items for a project iteration are defined. Scope items can include work items, tasks, to-do lists, project milestones, and any other component of the project iteration which is required to be addressed or completed in order to successfully complete the project iteration.

Scope items can be defined by user input. For example, a project manager can define scope items by inputting the scope items into a project management system. Scope items can be defined solely at the discretion of the project manager, or alternatively, can be defined collectively by a group of individuals or entities involved in the project. In another embodiment, scope items can be defined by individual users have access to the project management system. For example, a database administrator can input scope items relating to the database development of a project, and where a software architect can input scope items relating to a front-end graphical interface for a project. Thus, owners of specific components of a project can input scope items relating to their technical area or area of expertise.

In step 204, each scope item is associated with at least one tag. Tags can include requirements for the scope item, for example, required skills set of a resource, experience level or a resource, estimated time for completion, priority or importance of the scope item, and/or cost to complete the scope item. In addition, a tag can include a group identifier, so that related scope items can be identified as a group through a tag. For example, all scope items related to database development can be tagged as “Database”. The tags can include any information relating to requirements necessary or ideal in order to complete the scope item.

The scope items can be associated with tags through the project management system. Tags can be user-defined by a project manager or other individuals involved in a project. In another embodiment, tags can be automatically generated by the project management system based on the project iteration description. For example, once a project iteration description is entered into the project management system, the system can scan the keywords in the description and generate a list of suggested tags. The project manager can use these tags, as well as modify these tags, and remove and add additional tags.

In step 206, resources that are potentially available to work on the project iteration are identified. Resources can be identified from a pool of resources, such as employees in a company, or employees within a particular department, such as the “Software Development” department. In an embodiment, resources can include organizations, such as third-party companies, or entire departments with a company. As above, the project manager can select potentially available resources from a list using the project management system.

Furthermore, the project management system can indicate the schedule of the resources so that the project manager can determine if the resource would potentially be available for the entire project iteration, or a portion thereof, due to scheduled vacation or pre-existing commitments to other projects.

In another embodiment, the project management system can automatically suggest potentially available resources by scanning the keywords in the project description and matching up with identifiers associated with each resource in the pool of resources.

In step 208, each resource identified as potentially available is associated with at least one tag. These resource tags can include, for example, a skill set, an education level, an experience level, such as the number of years in the field, a general area of expertise, such as “Software Development”, and/or a specific area of expertise, such as “SQL Database Programming”.

In an embodiment, a tag can also include an indicator as to the resource's past performance. For example, a resource that has a positive past performance, based on evaluations and feedback from managers or peers, would have a high indicator. However, a resource having negative feedback indicating poor past performance on projects would have a low indicator.

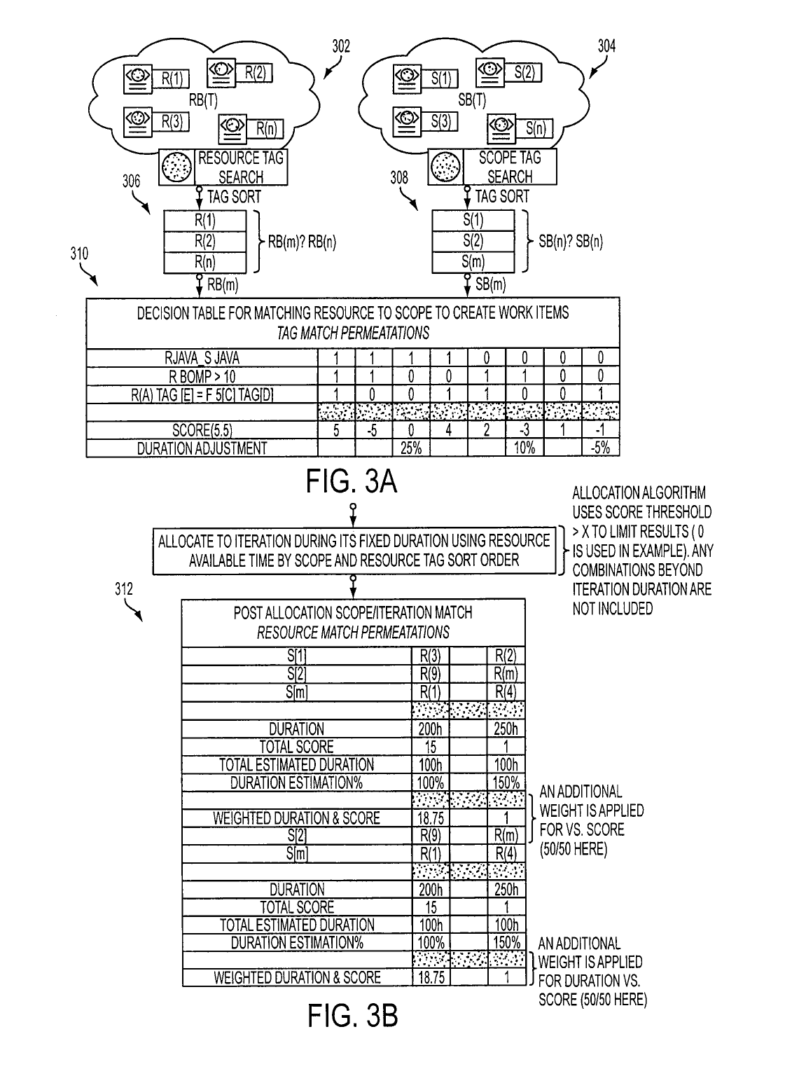

In step 210, a matching score is determined for each scope item based on a decision matrix. The matrix is described in more detail below in the discussion of FIG. 3. The matching score is based on matching scope item tags and resource tags between a range of values corresponding to these tags.

In step 212, a work priority is determined for each scope item. This work priority is based on a matching score between a particular scope item's tags and resource tags for a plurality of resources. A higher matching score indicates that the scope item requirements are more fully met by the available resources. A lower matching score indicates that the scope item requirements are not fully met by the available resources. If a scope item has a high scope item score, the scope item receives a higher priority so that it can be executed in a timely manner during the project iteration. On the other hand, if a scope item has a low scope item score, the scope item receives a lower priority and it is not placed in queue to be executed as quickly as higher priority scope items. In the case of low priority scope items, the project manager may use the additional time to seek additional resources which are more qualified or more suitable to meet the scope item's requirements.

In step 214, a plurality of completion paths are calculated by the project management system. In step 216, the system displays all possible paths that can be taken to complete the project iteration, based on various resource availability and allocation to various scope items. The system can display all possible paths, or in an embodiment, can display the most efficient paths, in terms or time, cost, or resource allocation.

In an embodiment, the path having the lowest score is the most effective combination of tag criteria and resource availability, and can automatically be displayed. In another embodiment, the user is presented with the most effective combination, as well as other combinations, so that the user can compare and choose the most practical path.

FIG. 3A shows an exemplary embodiment of the decision matrix. In an embodiment, the decision matrix is generated by an algorithm which can be coded in Extensible Markup Language (XML) and associated technologies such as XQuery. However, the algorithm can just as easily be described using relational entities and structured query language (SQL), as well as other equivalent programming languages.

In an embodiment, the following variables are used in the algorithm:

Resource: Rₙ, a set of XML
Resource Tag: RₙTₘ, an XML Tag within Rₙ
Resource Tag Value: V(RₙTₘ₎
Scope Item: Sₙ, a Set of XML
Scope Item Work Estimate: SₙE
Scope Item Work Dependency: SₙD
Scope Item Work Dependency Type: SₙDT = {FF,SS,SF,FS}
Scope Item Score Tolerance: SₙT ,<- Score tolerance for resource
allocation
Scope Item Tag: SₙTₘ, an XML Tag within Sₙ
Scope Item Tag Value: V(SₙTₘ)
Tag: Tₙ
RB_{T} = {R₁, R₂, R₃, ... Rₙ: n ε |, n = Total number of Rescurces}
RB_{T} = {S₁, S₂, S₃, ... Sₙ: n ε |, n = Total number of Scope}
RT_{T} =
( RₙTₘ|n ε | [symbol] n > 0 [symbol] n ≦ total number of resources [symbol]
m ε | [symbol] m > 0 [symbol] m ≦ total number of resources
RT_{T} =
( RₙTₘ|n ε | [symbol] n > 0 [symbol] n ≦ total number of resources [symbol]
m ε | [symbol] m > 0 [symbol] m ≦ total number of resources
ST_{T} =
( SₙTₘ|n ε | [symbol] n > 0 [symbol] n ≦ total number of scope [symbol]
m ε | [symbol] m > 0 [symbol] m ≦ total number of scope la
ST_{T} =
( SₙTₘ|n ε | [symbol] n > 0 [symbol] n ≦ total number of scope [symbol]
m ε | [symbol] m > 0 [symbol] m ≦ total number of scope la

The resource tag search can be easily implemented using a multitude of existing query and search facilities such as XQuery, shown here, SQL, or an existing markup search engine:

Input: RB_{T}RB_{T}, XQuery(RT_{X}RT_{X}), RT_{T}RT_{T} where RT_{X} ⊃ RT_{T} [symbol] RT_{S} ⊃ RT_{T}RT_{X} ⊃ RT_{T} [symbol] RT_{S} ⊃ RT_{T}
Output:
RBₘ = {Rₙ|n ε N [symbol] n ≦ total number of resources [symbol] satisfying XQuery(RT_{X}) [symbol] ordered by RT_{S}}
RBₘ = {Rₙ|n ε N [symbol] n ≦ total number of resources [symbol] satisfying XQuery(RT_{X}) [symbol] ordered by RT_{S}}

The scope item tag search can be easily implemented using a multitude of existing query and search facilities such as XQuery, shown here, SQL, or an existing markup search engine:

Input: SB_{T}SB_{T}, XQuery(ST_{X}ST_{X}), ST_{T}ST_{T} where ST_{X} ⊃ ST_{T} [symbol] ST_{S} ⊃ ST_{T}ST_{X} ⊃ ST_{T} [symbol] ST_{S}⊃ ST_{T}
Output:
SBₙ = {Sₙ|n ε N [symbol] n ≦ total number of scope items [symbol] satisfying XQuery(ST_{X}) [symbol] ordered by ST_{S}}
SBₙ = {Sₙ|n ε N [symbol] n ≦ total number of scope items [symbol] satisfying XQuery(ST_{X}) [symbol] ordered by ST_{S}}

Below is the algorithm for the decision matrix:

$${C}_{T} = \{ \begin{matrix}( v ( x ) = v ( y ) ) \\ U ( v ( x ) \neq v ( y ) ) \\ U ( v ( x ) < v ( y ) ) \\ U ( v ( x ) > v ( y ) ) \\ U ( v ( x ) \leq v ( y ) ) \\ U ( v ( x ) \geq v ( y ) )\end{matrix} \vert ( \begin{matrix}( x ɛ {RT}_{T} Vv ( x ) ɛ RVv ( x ) ɛ XQuery ( ⊇ {RT}_{T} ) ) \\ A ( y ɛ {ST}_{T} Vv ( y ) ɛ RVv ( y ) ɛ XQuery ( ⊇ {ST}_{T} ) )\end{matrix} ) \} U \{ x \vert x ɛ XQuery ( ( ⊇ {RT}_{T} ) U ( ⊇ {ST}_{T} ) \} \\ {C}_{T} = \{ \begin{matrix}( v ( x ) = v ( y ) ) \\ U ( v ( x ) \neq v ( y ) ) \\ U ( v ( x ) < v ( y ) ) \\ U ( v ( x ) > v ( y ) ) \\ U ( v ( x ) \leq v ( y ) ) \\ U ( v ( x ) \geq v ( y ) )\end{matrix} \vert ( \begin{matrix}( x ɛ {RT}_{T} Vv ( x ) ɛ RVv ( x ) ɛ XQuery ( ⊇ {RT}_{T} ) ) \\ A ( y ɛ {ST}_{T} Vv ( y ) ɛ RVv ( y ) ɛ XQuery ( ⊇ {ST}_{T} ) )\end{matrix} ) \} U \{ x \vert x ɛ XQuery ( ( ⊇ {RT}_{T} ) U ( ⊇ {ST}_{T} ) \}$$

### Decision Matrix

$$ρ = {\sum }_{x = 0}^{T} ( \begin{matrix}T \\ x\end{matrix} ) {\sum }_{x = 0}^{T} ( \begin{matrix}T \\ x\end{matrix} )$$

Condition Permutations: For each Cₙ where n<T there is a flag for each C so that a matrix can be constructed for all permutations of C. The number of permutations is size p.

C_{(x⊂N≦T),y≦p}=(1 0)C_{(x⊂N≦T),y≦p}=(1 0)

Scores: There is a set of scores, S, which are assigned to each permutation. A higher score indicates a more desirable combination of resource and a scope lag criteria used to determine schedule allocation.

SC_{T+1,y≦p}={x|x ε Z}SC_{T+1,y≦p}{x|x ε Z}

Duration Adjustment: There is a percentage assigned to each permutation indicated by how much to adjust any calculated duration based on the permutation.

$${DA}_{T + 2 , y \leq p} = \{ x \vert x ɛ R \} {DA}_{T + 2 , y \leq p} = \{ x \vert x ɛ R \}$$

$${D}_{T} = [ \begin{matrix}{C}_{11} & … & {C}_{1 p} \\ ⋮ & ⋰ & ⋮ \\ {C}_{T 1} & … & {C}_{Tp} \\ {SC}_{( T + 1 , 1 )} & … & {SC}_{( T + 1 , p )} \\ {DA}_{( T + 2 , 1 )} & … & {DA}_{( T + 2 , p )}\end{matrix} ] {D}_{T} = [ \begin{matrix}{C}_{11} & … & {C}_{1 p} \\ ⋮ & ⋰ & ⋮ \\ {C}_{T 1} & … & {C}_{Tp} \\ {SC}_{( T + 1 , 1 )} & … & {SC}_{( T + 1 , p )} \\ {DA}_{( T + 2 , 1 )} & … & {DA}_{( T + 2 , p )}\end{matrix} ]$$

Iteration: The allocation algorithm allocates resources to an iteration which is defined as follows:
Iₙ=Iteration n
IₙS=Iteration n start date
IₙE=Iteration n end date

In an embodiment, the matrix, as shown below, is a multidimensional structure holding resource scope item allocation information and an allocation flag indicating which scope item the resource is assigned to for that period of time. The structure can be dissembled into a series of matrices representing the years, months, days, hours, and minute dimensions. A reason for disabling this information is to quicken allocation.

$$ISA = \{ S \vert S ɛ {SB}_{n} \} ISA = \{ S \vert S ɛ {SB}_{n} \} ← Allocated Space$$

$$IRA = \{ R \vert R ɛ {RB}_{m} \} IRA = \{ R \vert R ɛ {RB}_{m} \} ← Allocated Resource \\ IxC = \{ 01 \} IxC = \{ 01 \} ← Complete for x = Year ( Y ) , \\ Month ( M ) , Day ( D ) , Hour ( H ) and minutes ( m ) respectively \\ IY = \{ y \vert y ɛ Valid Year y \geq {I}_{n} S y \leq {I}_{n} E \} \\ IY = \{ y \vert y ɛ Valid Year y \geq {I}_{n} S y \leq {I}_{n} E \} \\ {IYA}_{n} = [ \begin{matrix}{IY}_{11} & … & {IY}_{1 n} \\ {IRA}_{21} & … & {IRA}_{2 n} \\ {ISA}_{31} & … & {ISA}_{3 n} \\ {IYC}_{41} & … & {IYC}_{4 n}\end{matrix} ] \\ {IYA}_{n} = [ \begin{matrix}{IY}_{11} & … & {IY}_{1 n} \\ {IRA}_{21} & … & {IRA}_{2 n} \\ {ISA}_{31} & … & {ISA}_{3 n} \\ {IYC}_{41} & … & {IYC}_{4 n}\end{matrix} ] ← Year$$

$$IM = \{ M \vert M ɛ N M \leq 12 M \geq {I}_{n} S M \leq {I}_{n} E \}$$

$$IM = \{ M \vert M ɛ N M \leq 12 M \geq {I}_{n} S M \leq {I}_{n} E \}$$

$${IMA}_{n} = [ \begin{matrix}{IY}_{11} & … & {IY}_{1 n} \\ {IM}_{21} & … & {IM}_{2 n} \\ {IRA}_{31} & … & {IRA}_{3 n} \\ {ISA}_{41} & … & {ISA}_{4 n} \\ {IMC}_{51} & … & {IMC}_{5 n}\end{matrix} ] {IMA}_{n} = [ \begin{matrix}{IY}_{11} & … & {IY}_{1 n} \\ {IM}_{21} & … & {IM}_{2 n} \\ {IRA}_{31} & … & {IRA}_{3 n} \\ {ISA}_{41} & … & {ISA}_{4 n} \\ {IMC}_{51} & … & {IMC}_{5 n}\end{matrix} ] \\ ID = \{ d \vert d ɛ N m \leq 31 d \geq {I}_{n} S d \leq {I}_{n} E \} \\ ID = \{ d \vert d ɛ N m \leq 31 d \geq {I}_{n} S d \leq {I}_{n} E \} \\ {IDA}_{n} = [ \begin{matrix}{IY}_{11} & … & {IY}_{1 n} \\ {IM}_{21} & … & {IM}_{2 n} \\ {ID}_{31} & … & {ID}_{3 n} \\ {IRA}_{41} & … & {IRA}_{4 n} \\ {ISA}_{51} & … & {ISA}_{5 n} \\ {IDC}_{61} & … & {IDC}_{6 n}\end{matrix} ]$$

$${IDA}_{n} = [ \begin{matrix}{IY}_{11} & … & {IY}_{1 n} \\ {IM}_{21} & … & {IM}_{2 n} \\ {ID}_{31} & … & {ID}_{3 n} \\ {IRA}_{41} & … & {IRA}_{4 n} \\ {ISA}_{51} & … & {ISA}_{5 n} \\ {IDC}_{61} & … & {IDC}_{6 n}\end{matrix} ] \\ {IHA}_{n} = \{ h \vert h ɛ \vert Z \vert h \leq 23 h \geq {I}_{n} S h \leq {I}_{n} E \} \\ {IHA}_{n} = \{ h \vert h ɛ \vert Z \vert h \leq 23 h \geq {I}_{n} S h \leq {I}_{n} E \} \\ {IHA}_{n} = [ \begin{matrix}{IY}_{11} & … & {IY}_{1 n} \\ {IM}_{21} & … & {IM}_{2 n} \\ {ID}_{31} & … & {ID}_{3 n} \\ {IH}_{41} & … & {IH}_{4 n} \\ {IRA}_{51} & … & {IRA}_{5 n} \\ {ISA}_{61} & … & {ISA}_{6 n} \\ {IHC}_{71} & … & {IHC}_{7 n}\end{matrix} ] {IHA}_{n} = [ \begin{matrix}{IY}_{11} & … & {IY}_{1 n} \\ {IM}_{21} & … & {IM}_{2 n} \\ {ID}_{31} & … & {ID}_{3 n} \\ {IH}_{41} & … & {IH}_{4 n} \\ {IRA}_{51} & … & {IRA}_{5 n} \\ {ISA}_{61} & … & {ISA}_{6 n} \\ {IHC}_{71} & … & {IHC}_{7 n}\end{matrix} ] \\ Im = \{ m \vert m ɛ \vert Z \vert m \leq 59 m \geq {I}_{n} S m \leq {I}_{n} E \} \\ Im = \{ m \vert m ɛ \vert Z \vert m \leq 59 m \geq {I}_{n} S m \leq {I}_{n} E \} \\ {ImA}_{n} = [ \begin{matrix}{IY}_{11} & … & {IY}_{1 n} \\ {IM}_{21} & … & {IM}_{2 n} \\ {ID}_{31} & … & {ID}_{3 n} \\ {IH}_{41} & … & {IH}_{4 n} \\ {Im}_{51} & … & {IRA}_{5 n} \\ {IRA}_{61} & … & {IRA}_{6 n} \\ {ISA}_{71} & … & {ISA}_{7 n} \\ {ImC}_{81} & … & {ImC}_{8 n}\end{matrix} ] {ImA}_{n} = [ \begin{matrix}{IY}_{11} & … & {IY}_{1 n} \\ {IM}_{21} & … & {IM}_{2 n} \\ {ID}_{31} & … & {ID}_{3 n} \\ {IH}_{41} & … & {IH}_{4 n} \\ {Im}_{51} & … & {Im}_{5 n} \\ {IRA}_{61} & … & {IRA}_{6 n} \\ {ISA}_{71} & … & {ISA}_{7 n} \\ {ImC}_{81} & … & {ImC}_{8 n}\end{matrix} ]$$

Below is a sample graphical representation of the structure:

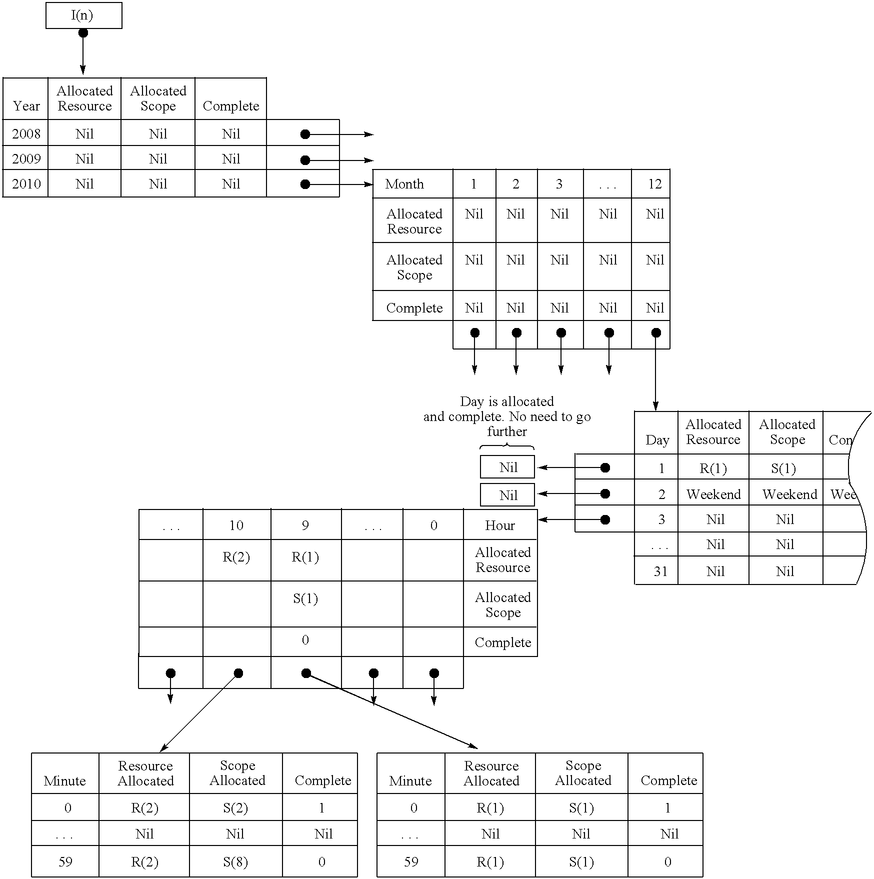

In an embodiment, this invention deals with a multidimensional structure that uses a generic roll-up function to determine allocation, as shown below. In order to roll up the result, every dimension is converted to minutes. In an alternative embodiment, every dimension may be converted to another time denomination, such as hours, days, weeks, etc.

allocated(R,S)=IY×(# of days in year)×24×60+IM×(# of days in month)×24×60+ID×24×60+IH×60+Im=minutes allocated

The following roll-up function results in the number of minutes allocated for a particular resource and scope item item. A Nil result indicates that a particular scope item element is not allocated. The percent completion of a particular scope item element is determined using the formula below:

complete(R,S)=(IY×(# of days in year)×24×60×IYC+IM×(# of days in month)×24×60×IMC+ID×24×60×IDC+IH×60×IHC÷Im×ImC)÷complete(R,S)=(IY×(# of days in year)×24×60×IYC+IM×(# of days in month)×24×60×IMC+ID×24×60×IDC+IH×60×IHC÷Im×ImC)÷allocated(R,S)

The following roll-up function determines the earliest start date of a resource in iteration:

earliestSD(R)=MIN Uₓ₌₁^{x=n}[IY(SBₓ)×(# of days in year)×24×60×IYC(SBₓ)⁻¹+IM(SBₓ)×(# of days in month)×24×60×IMC(SBₓ)⁻¹+ID(SBₓ)×24×60×IDC(SBₓ)⁻¹+IH(SBₓ)×60×IHC(SBₓ)×Im(SBₓ)×ImC(SBₓ)]

earliestSD(R)=MIN Uₓ₌₁^{x=n}[IY(SBₓ)×(# of days in year)×24×60×IYC(SBₓ)⁻¹+IM(SBₓ)×(# of days in month)×24×60×IMC(SBₓ)⁻¹+ID(SBₓ)×24×60×IDC(SBₓ)⁻¹+IH(SBₓ)×60×IHC(SBₓ)×Im(SBₓ)×ImC(SBₓ)]

The following rollup function the length of a continuous duration given a start date:

duration(R,S)=MIN Uₓ₌₁^{x=n}[IY(SBₓ)×(# of days in year)×24×60×IYC(SBₓ)⁻¹+IM(SBₓ)×(# of days in month)×24×60×IMC(SBₓ)⁻¹+ID(SBₓ)×24×60×IDC(SBₓ)⁻¹+IH(SBₓ)×60×IHC(SBₓ)×Im(SBₓ)×ImC(SBₓ)]

duration(R,S)=MIN Uₓ₌₁^{x=n}[IY(SBₓ)×(# of days in year)×24×60×IYC(SBₓ)⁻¹+IM(SBₓ)×(# of days in month)×24×60×IMC(SBₓ)⁻¹+ID(SBₓ)×24×60×IDC(SBₓ)⁻¹+IH(SBₓ)×60×IHC(SBₓ)×Im(SBₓ)×ImC(SBₓ)]

The above roll-up functions are provided as exemplary functions, and have been provided to give a general understanding on how availability is determined. Functions having equivalent results may be used, as well as functions utilizing different programming methods.

In an embodiment, the matrix, as shown below, is a multidimensional structure holding resource scope item allocation information and an allocation flag indicating which scope item the resource is assigned to for that period of time. The structure is disassembled into a series of matrices representing years, months, days, hours, and minute dimensions. The matrix information is combined with iteration information to produce an allocation calendar that functions described in the iteration calendar section operate on. When allocations are committed against a resource for a particular iteration, an allocation is made against the resource calendar. Calendars are used by executing a union of calendar information.

$$RSA = \{ S \vert S ɛ {SB}_{T} \} RSA = \{ S \vert S ɛ {SB}_{T} \} ← Allocated ( this can be Scope , weekend , vacation , for description simplicity we assume scope is allocated exclusively )$$

$$RY = \{ y \vert y ɛ Valid Year \} RY = \{ y \vert y ɛ Valid Year \}$$

$${RYA}_{n} = [ \begin{matrix}{RY}_{11} & … & {RY}_{1 n} \\ {RSA}_{21} & … & {RSA}_{2 n}\end{matrix} ]$$

$${RYA}_{n} = [ \begin{matrix}{RY}_{11} & … & {RY}_{1 n} \\ {RSA}_{21} & … & {RSA}_{2 n}\end{matrix} ] ← Year$$

$$RM = \{ M \vert M ɛ NAM \leq 12 \} RM = \{ M \vert M ɛ NAM \leq 12 \}$$

$${RMA}_{n} = [ \begin{matrix}{RY}_{11} & … & {RY}_{1 n} \\ {RM}_{21} & … & {RM}_{2 n} \\ {RSA}_{31} & … & {RSA}_{3 n}\end{matrix} ] {RMA}_{n} = [ \begin{matrix}{RY}_{11} & … & {RY}_{1 n} \\ {RM}_{21} & … & {RM}_{2 n} \\ {RSA}_{31} & … & {RSA}_{3 n}\end{matrix} ]$$

$$RD = \{ d \vert d ɛ NAm \leq 31 \} RD = \{ d \vert d ɛ NAm \leq 31 \} \\ {RDA}_{n} = [ \begin{matrix}{RY}_{11} & … & {RY}_{1 n} \\ {RM}_{21} & … & {RM}_{2 n} \\ {RD}_{31} & … & {RD}_{3 n} \\ {RSA}_{41} & … & {RSA}_{4 n}\end{matrix} ] {RDA}_{n} = [ \begin{matrix}{RY}_{11} & … & {RY}_{1 n} \\ {RM}_{21} & … & {RM}_{2 n} \\ {RD}_{31} & … & {RD}_{3 n} \\ {RSA}_{41} & … & {RSA}_{4 n}\end{matrix} ] \\ RH = \{ h \vert h ɛ \vert Z \vert h \leq 23 \} RH = \{ h \vert h ɛ \vert Z \vert h \leq 23 \}$$

$${RHA}_{n} = [ \begin{matrix}{RY}_{11} & … & {RY}_{1 n} \\ {RM}_{21} & … & {RM}_{2 n} \\ {RD}_{31} & … & {RD}_{3 n} \\ {RH}_{41} & … & {RH}_{4 n} \\ {RSA}_{51} & … & {RSA}_{5 n}\end{matrix} ] {RHA}_{n} = [ \begin{matrix}{RY}_{11} & … & {RY}_{1 n} \\ {RM}_{21} & … & {RM}_{2 n} \\ {RD}_{31} & … & {RD}_{3 n} \\ {RH}_{41} & … & {RH}_{4 n} \\ {RSA}_{51} & … & {RSA}_{5 n}\end{matrix} ]$$

$$Rm = \{ m \vert m ɛ \vert Z \vert m \leq 59 \} Rm = \{ m \vert m ɛ \vert Z \vert m \leq 59 \} \\ {RmA}_{n} = [ \begin{matrix}{RY}_{11} & … & {RY}_{1 n} \\ {RM}_{21} & … & {RM}_{2 n} \\ {RD}_{31} & … & {RD}_{4 n} \\ {RH}_{51} & … & {RH}_{5 n} \\ {Rm}_{61} & … & {Rm}_{6 n} \\ {RSA}_{71} & … & {RSA}_{7 n}\end{matrix} ] {RmA}_{n} = [ \begin{matrix}{RY}_{11} & … & {RY}_{1 n} \\ {RM}_{21} & … & {RM}_{2 n} \\ {RD}_{31} & … & {RD}_{4 n} \\ {RH}_{51} & … & {RH}_{5 n} \\ {Rm}_{61} & … & {Rm}_{6 n} \\ {RSA}_{71} & … & {RSA}_{7 n}\end{matrix} ]$$

Below is a sample graphical representation of the structure:

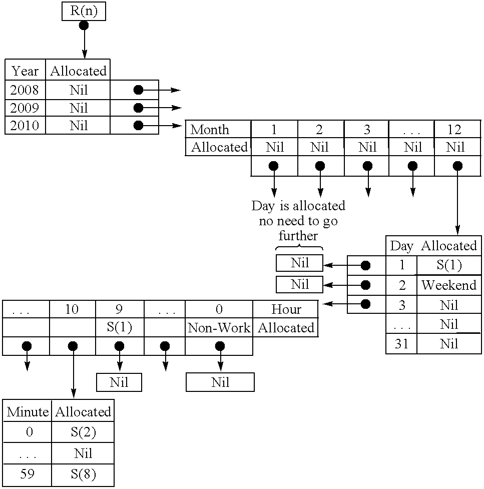

The allocation matrix includes the maximum number of resource and scope item allocation scenarios which can be conceived of when allocating resource and scope item to the iteration as defined as follows. The width and height of this matrix is determined by the number of unique resource assignment permutations that can exist and is represented by:

$$S = {m}^{n} , where m is the number of resource and n is the number of scope elements to allocate$$

$$T D = Total Duration$$

$$T S = Total Score$$

$$T E S = Total Estimated Duration$$

$$D E P = Duration / Estimate Percentage$$

$$T D S = Total Duration Score$$

$${A}_{X} = [ \begin{matrix}{SB}_{10} & {RB}_{11} & … & {RB}_{1 S} \\ ⋮ & ⋮ & ⋰ & ⋮ \\ {SB}_{n 0} & {RB}_{n 1} & … & {RB}_{nS} \\ Nil & T {D}_{n + 1 , 1} & … & T {D}_{n + 1 , S} \\ Nil & T {S}_{n + 2 , 1} & … & T {S}_{n + 2 , S} \\ Nil & T E {D}_{n + 3 , 1} & … & T E {D}_{n + 3 , S} \\ Nil & D E {P}_{n + 4 , 1} & … & D E {P}_{n + 4 , S} \\ Nil & T D {S}_{n + 5 , 1} & … & T D {S}_{n + 5 , S}\end{matrix} ]$$

$${A}_{X} = [ \begin{matrix}{SB}_{10} & {RB}_{11} & … & {RB}_{1 S} \\ ⋮ & ⋮ & ⋰ & ⋮ \\ {SB}_{n 0} & {RB}_{n 1} & … & {RB}_{nS} \\ Nil & T {D}_{n + 1 , 1} & … & T {D}_{n + 1 , S} \\ Nil & T {S}_{n + 2 , 1} & … & T {S}_{n + 2 , S} \\ Nil & T E {D}_{n + 3 , 1} & … & T E {D}_{n + 3 , S} \\ Nil & D E {P}_{n + 4 , 1} & … & D E {P}_{n + 4 , S} \\ Nil & T D {S}_{n + 5 , 1} & … & T D {S}_{n + 5 , S}\end{matrix} ]$$

The function to calculate the score is shown below:

```
    Input: {Cₓ,Dₓ,R,S|Cₓ ⊃ C_{T},Dₓ ⊃D_{T}} Input: {Cₓ,Dₓ,R,S|Cₓ ⊃
    C_{T},Dₓ ⊃ D_{T} }
Output: { Score, Duration adjustment }Output: { Score, Duration
adjustment }
matchset = { }
for i = 1 to x do
```

| | |
|---|---|
| matchset = matchset ∪ C,(R,S) | // builds a set of condition results |
| end for | |
| for k = 1 to p do | |
| match = 0 | |
| for j = 1 to x do | // See definition of p above in D matrix |
| | description |
| if Dⱼₖ = Cⱼ (R,S) then | |
| match = 1 | |
| else | |
| match = 0 | |
| end if | |
| end for | |
| if match = 1 then | |
| leave for | |
| end if | |
| end for | |
| return D_{x+1,k}D_{x+2,k} | |

The function to build scope item stack is shown below:

```
Input: {SBₙ} Input: {SBₙ}
      Output: { SB₀| Where the scope elements are ordered in terms
      Output: { SB₀| Where the scope elements are ordered in terms
      of allocation priority according to dependencies, it also defects circular dependencies}
of allocation priority according to dependencies, it also defects circular dependencies}
```

| | |
|---|---|
| scopestack₀ = { } | // This will contain our ordered scope stack |
| for i = 1 to n do | // Work our way through the ordered scope |
| list | |
| scopestack^{s} = localstack¹ = {SB₁} | // local stack to check for circular |
| dependencies | |
| currentscope = SB₁D | |
| while currentscope <> nil then | // if there is a predecessor dependency, it |
| must be resolved first | |
| if localstack contains current scope then | |
| error ( “Circular dependency detected” ) | |
| end if | |
| localstack^{t} = localstackₜ ∪ (currentscope) | // Walk backwards and keep trail by |
| oushing onto a stack | |
| end while | |
| scopestack^{s} = scopestack^{s} ∪ localstack^{t} | // Pick up all unique elements onto |
| scope stack | |
| end for | |
| return scopestack | |

An exemplary allocate algorithm is shown below:

Input: {I_{q}(YA,MA,DA,HA,mA),Cₓ,Dₓ,RBₘ(YA,MA,DA,HA,mA),SBₙ|
Cₓ ⊃ C_{T},Dₓ ⊃ D_{T}}
Input: {I_{q}(YA,MA,DA,HA,mA),Cₓ,Dₓ,RBₘ(YA,MA,DA,HA,mA),SBₙ|
Cₓ ⊃ C_{T},Dₓ ⊃ D_{T}}
Output: {I_{q}(YA,MA,DA,HA,mA),RBₘ(YA,MA,DA,HA,mA),Aₙ}
Output: {I_{q}(YA,MA,DA,HA,mA),RBₘ(YA,MA,DA,HA,mA),Aₙ}

In an embodiment, the present invention includes a set of ordered scope item elements which can be combined with a resource in the resource pool to produce a score. The goal is to find an optimum set of scope item-resource combinations so that the score and duration are maximized using a 50/50, for example, distribution of score and duration. In order to reduce the complexity of the problem, a cut off score is assigned to a scope item to take certain combinations out of contention immediately.

To find the best combination of resource allocations in order to minimize the duration and maximize the number of scope item items addressed in a given iteration, the present invention determines the shortest path for four trees rooted with one of the base combinations contained within the first set (scope item element bottom of the scope item stack) to each of the combinations within the last set (scope item element at the top of the stack). We therefore have a multiple of single source to multiple destination shortest path problems equal in number to the number of scope item elements under consideration.

As these trees are travesered, scores are calculated based on the condition matching table scores and a duration is calculated based on calendar information. These are excluded from certain branches if threshold values (SnT, InE) described above, are exceeded (an infinite cost path).

The dependency type (SnDT) of the predecessor node also determines whether a particular path can be followed by examining the predecessors' allocation information and attempting to allocate the resource within the bounds (FF, SS, SF, FS). For example, if the shortest path algorithm is calculating the cost of a particular node, it will take duration information into account. In order to determine the duration, the allocation will be attempted making sure the constraints are satisfied. If they cannot be satisfied, the path is marked as infinite cost.

Therefore, in order to produce the matrix A, and find the best match of scope item/resource allocation combination we can use one of the well-established algorithms to find the best route such as Dijkstra's algorithm, the Bellman-Form algorithm, or the A*/B* search algorithm, or find all routes using: the Flyod-Warshall algorithm or Johnson's algorithm. There are several other algorithms and methods not mentioned above which may also be used to achieve desired results in conjunction with the present invention. Once the shortest path is found, it is allocated against the iteration and the matrix A, either showing all combinations or the best path combination chosen depending on the algorithm used.

In an embodiment, it is possible for the matrix A not to be committed to the iteration calendar and allow a path to be chosen and applied by the user of the system based on some other considerations.

Now, illustrative examples of how the above algorithm is utilized will be discussed. During execution, as work items are performed and completed, they are either completed under, in, or over the estimate for the completion of the work item. If a work item is closed under the estimated time it can allocate more time at the tail end of the iteration for the resource to work on more scope items. If a scope item allocated to a resource is running over the estimated time then scope items at the tail end of the iteration may be bumped into subsequent iterations due to the amount of time left in the current iteration for a particular resource being shortened.

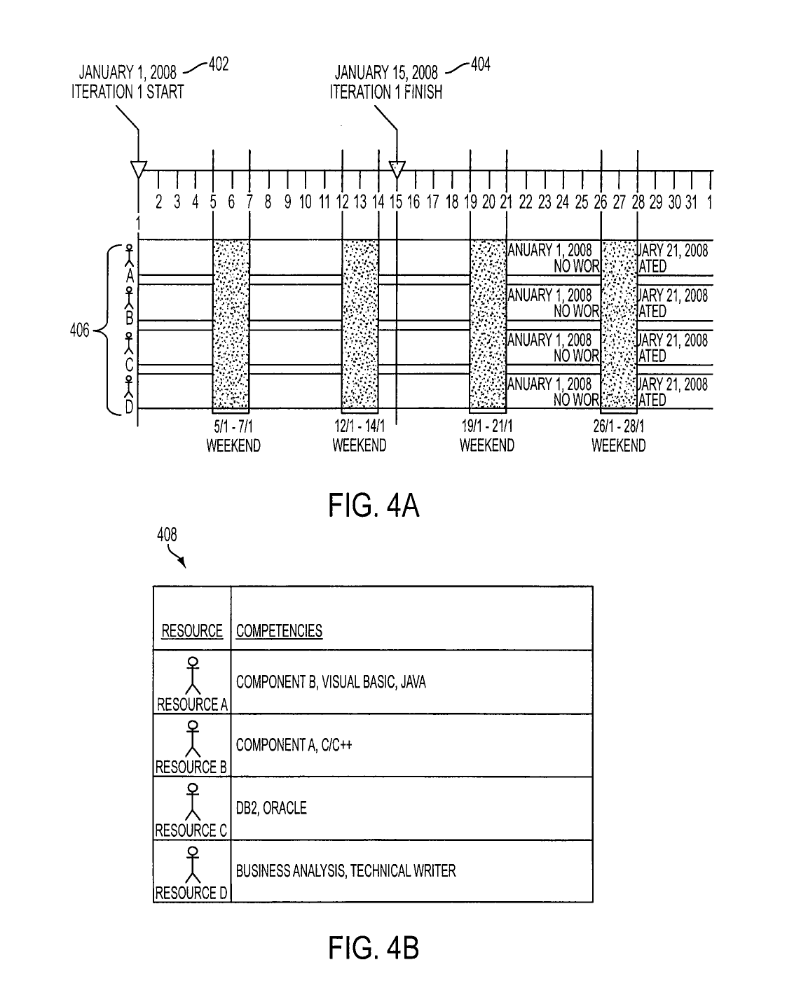

It may be possible that each work item in the group of scope items may have several resources that need to work on it. If this is the case, then it may be necessary to split the items on a resource activity basis and estimate the work at the resource level. Otherwise, in an embodiment, the leveling engine could use a work distribution formula, such as 50/50, for example. In FIGS. 4A and 4B, several items in the bucket of scope items are ready to be allocated to resources with varying skill sets and product component alignment that have been committed 100% onto the iteration. For illustrative purposes, the items in scope items have been prioritized estimated in days and marked with the skill set and/or component alignment desired. Some scope item constraints may indicate some mandatory conditions to be taken into account during leveling. For illustrative purposes, each workday has been defined as exactly 8 hours and that there are no other working times considered. However, the work day can be customizable and defined by the user to include any number of hours.

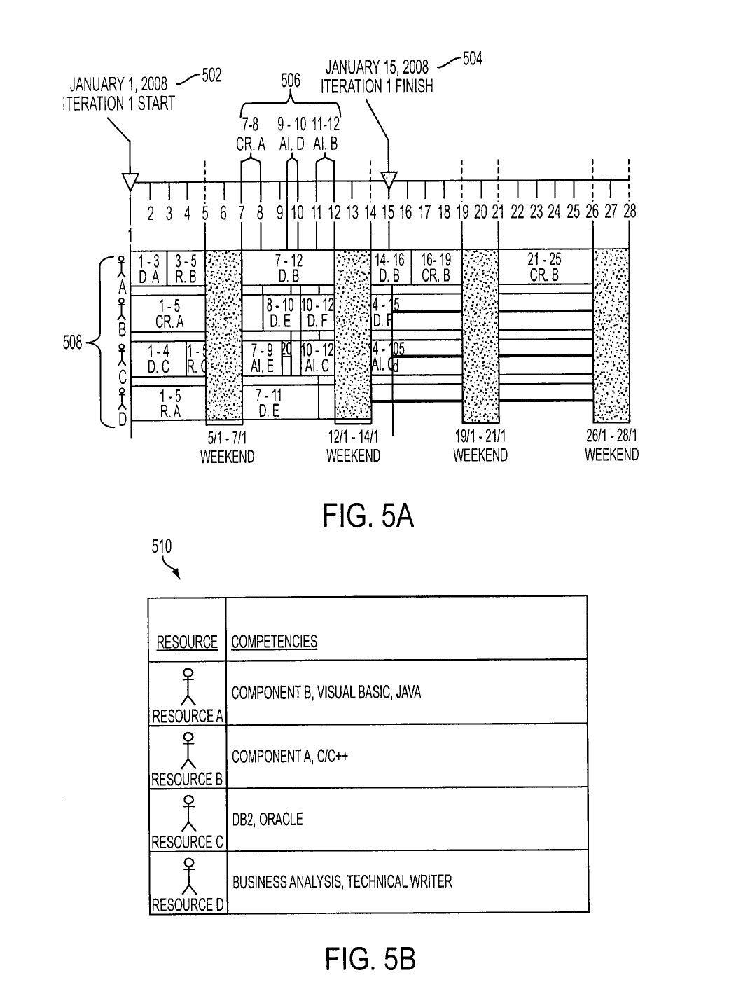

FIG. 4A illustrates an iteration calendar prior to execution of any scope items. In this situation the proposed leveling engine is ready to allocate work to resources given the priorities and constraints. Leveling the situation in FIG. 4A will result in the re-arrangement of the items in the bucket as shown in FIG. 5A.

FIG. 5A illustrates an iteration calendar after leveling during planning. It can be seen that adding another resource with similar competencies as “A” results in more content being fit into iteration 1. The following notations identify items in the schedule: D=Defect; CR=Change Request; R=Requirement; and AI=Action Item.

As seen in FIG. 5A, it is evident that the calendar is significant in determining availability of resources. It should be noted that iterations, projects, and resources themselves can also have calendars which create unavailable time slots into which work cannot be allocated. Usually, the resource calendar contains personal vacations, meetings, and other sundry time reservations where project, organization and other calendars can contain public or site holidays. For the illustrative purposes of describing the leveling algorithm, FIGS. 4, 5, and 6 assume that only one type of calendar exists, that of the resource.

FIG. 5A also assumes that the same calendar is being used by all resources, however, in actuality, resources may be globally distributed and may not share the same time zone, let alone same calendar. The leveling algorithm may take into account different time zones and periods of availability to level effectively.

In FIG. 5A, it can be seen that by adding a resource with a similar skill set as “A” will create a situation where most of the content will fit into the iteration.

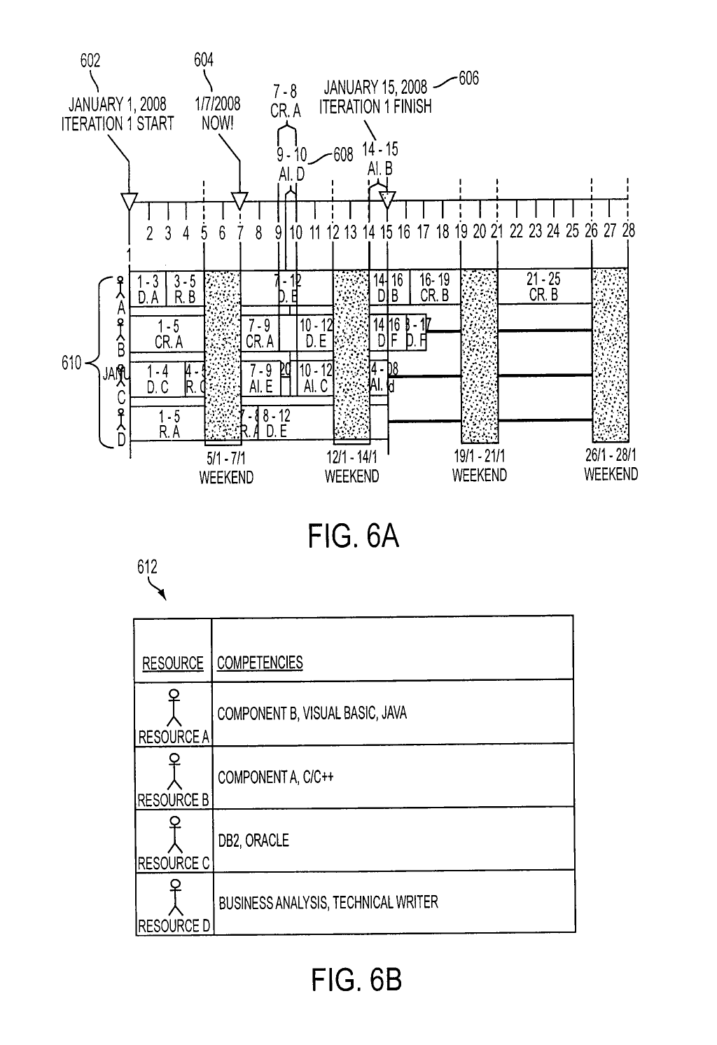

FIG. 6A illustrates an iteration calendar with leveling during execution. Leveling during execution is similar to leveling during planning except that time has progressed since the establishment of the plan, also referred to as the baseline. During the execution, the leveler needs to adjust the content forecast depending on whether items are being calculated under estimate or over estimate. FIG. 6 illustrates the iteration calendar with half of the of the iteration being executed and the following assumptions:
(1) One week of execution has passed.
(2) Change Request A is late.
(3) Requirement A is late.

The leveling engine will readjust the content in the schedule as seen in FIG. 6A. The illustration shows that Requirement A's delay has no effect on content based as the leveling algorithm can compensate for these types of delays.

The leveling algorithm can take into constraints and dependencies between items in the bucket. For instance, these constraints and dependencies can include that a bucket item must start before another has started, start after another has finished, finish before another has finished, and finish after another has started. When leveling the content between resources in an iteration or between iterations, bucket items may having dependencies to other bucket items assigned to other ongoing iterations are taken into account. Other types of constraints the leveling algorithm may take into account are must start dates, must end dates, and must start and must end dates together.

In an embodiment, a resource may be percent committed to a duration implying that their time is split between durations. The leveling algorithm then only uses the percentage of the time allotted in consideration when planning bucket items.

While the specification has been disclosed in relation to the exemplary and non-limiting embodiments provided herein, it is noted that the inventive principles are not limited to these embodiments and include other permutations and deviations without departing from the spirit of the invention.

1. A method of allocating tasks and resources for a project lifecycle, comprising:
defining a plurality of scope items for a project iteration on a database implemented on one or more computer systems;
associating each scope item with at least one tag, each tag being assigned one or more values related to a required skill or experience level;
identifying a plurality of resources available to work during the project iteration;
associating each resource with at least one tag;
determining a matching score for each scope item, the matching score based on a matching criteria between a range of values corresponding to the resource tags and the scope item tags;
determining a work priority for each scope item based on a matching score as determined by a decision matrix;
calculating a plurality of completion paths using the decision matrix, the completion paths based on various combinations of work priorities and resource allocations; and
displaying the total number of completions paths in a graph of all possible valid resource and scope item matches as determined by user assigned weights in the decision matrix,
wherein the path having a lowest score being the most effective combination of tag criteria and resource availability.
